(19) United States
(12) Patent Application Publication
(10) Pub. No.: US 2009/0153602 A1
(43) Pub. Date: Jun. 18, 2009

(54) Printing Cartridge Refill Method And Associated Cartridge Refill System

(76) Inventors: Thomas Daniel Brown, Frankfort, KY (US); William Henry Reed, Lexington, KY (US); Michael David Stilz, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/958,813

(22) Filed: Dec. 18, 2007

(51) Int. Cl. B41J 29/38

(52) U.S. Cl. 347/7

(57) ABSTRACT

A method for refilling a printing cartridge includes installing a printing cartridge in a cartridge refill system; establishing communication with a memory device associated with the printing cartridge to read cartridge data stored in the memory device; determining aspects of refilling of the printing cartridge based on at least a portion of the cartridge data; and refilling the printing cartridge based on a result of the determination.

### CROSS-REFERENCE TO RELATED APPLICATIONS

None.

### MICROFICHE APPENDIX

None.

### GOVERNMENT RIGHTS IN PATENT

None.

### BACKGROUND OF THE INVENTION

1. Field of the Invention

The present invention relates to printing cartridge refilling, and, more particularly, to a printing cartridge refill method and associated cartridge refill system.

2. Description of the Related Art

Printing cartridges, such as ink jet printhead cartridges, are designed primarily as a consumable supply item to be disposed after available imaging substance, e.g., ink, has been exhausted. For an ink jet printhead cartridge, quality and performance tend to degrade with usage for a variety of reasons including: clogging of nozzles by debris or dried ink, failure of heaters from cavitation erosion or thermal fatigue, corrosion or deterioration of printhead materials, buildup of organic thermal debris on the heaters (also known as kogation), leaching of surfactant chemicals from the foam often used to contain the ink within the cartridge, growth of bacteria or algae that clogs nozzles, buildup or precipitation of materials that were dissolved or suspended in the ink, and many other reasons. These examples are taken from thermal ink jet technology, but similar failure modes are present with piezoelectric ink jet technology.

Original inks are exhaustively tested during printer development. Third party inks sold for refills may have less comprehensive testing and may not be compatible with the original inks, or in the long term with materials used in the printhead. Taken together, these factors will cause performance of an ink jet printhead to change over time and print quality may be compromised. A single use of the printing cartridge minimizes these effects, but refilling significantly increases the probability of failure or degraded performance.

Motivated by desire for economy, convenience, and reduced waste, consumers have shown sustained interest in refilling cartridges with a fresh supply of imaging substance. It has been shown that original cartridges may be refilled multiple times, although consumers may find refilling cartridges to be messy and performance or print quality degraded.

What is needed in the art is a printing cartridge refill method and associated cartridge refill system that is convenient to use, while assuring that performance and print quality standards of the printing cartridge are sustained.

### SUMMARY OF THE INVENTION

The present invention provides a printing cartridge refill method and associated cartridge refill system that is convenient to use, while assuring that performance and print quality standards of the printing cartridge are sustained.

The invention, in one form thereof, is directed to a method for refilling a printing cartridge. The method includes installing a printing cartridge in a cartridge refill system; establishing communication with a memory device associated with the printing cartridge to read cartridge data stored in the memory device; determining aspects of refilling of the printing cartridge based on at least a portion of the cartridge data; and refilling the printing cartridge based on a result of the determination.

The invention, in another form thereof, is directed to a cartridge refill system for refilling a printing cartridge having a memory device. The cartridge refill system includes a print engine configured to mount the printing cartridge to be refilled and a cartridge refill device. The cartridge refill device has a refill reservoir containing at least an imaging substance, and has a refill interface device. The refill interface device is coupled to the refill reservoir and is configured to engage the printing cartridge. A controller is communicatively coupled to the print engine and the cartridge refill device. The controller executes program instructions to perform the acts of: establishing communication with the memory device associated with the printing cartridge to read cartridge data stored in the memory device; determining aspects of refilling of the printing cartridge based on at least a portion of the cartridge data; and refilling the printing cartridge based on a result of the determination.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an exemplary cartridge refill system, configured in accordance with an embodiment of the present invention.

FIG. 2 is a diagrammatic depiction of an exemplary cartridge refill device of the cartridge refill system of FIG. 1.

FIG. 3 is a general flowchart of a method for refilling a printing cartridge, in accordance with an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

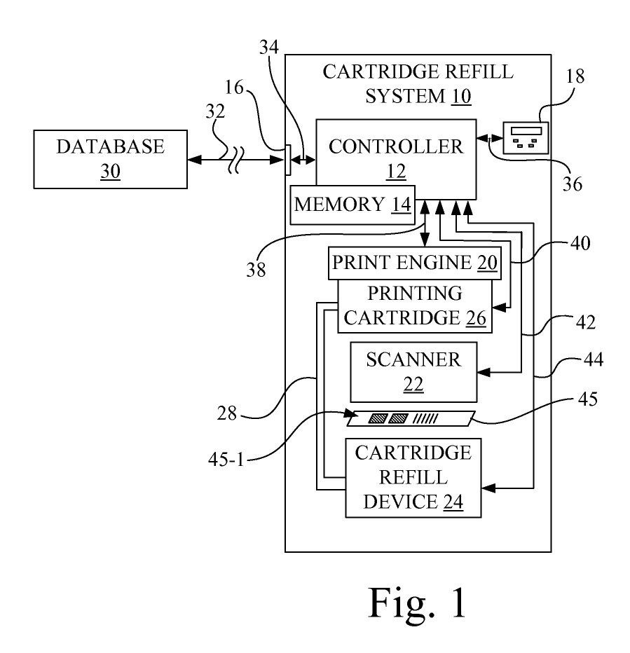

Referring now to the drawings and particularly to FIG. 1, there is shown a cartridge refill system 10 configured in accordance with an embodiment of the present invention.

Cartridge refill system 10 includes a controller 12, a memory 14, a communication port 16, a user interface 18, a print engine 20, a scanner 22 and a cartridge refill device 24. A printing cartridge 26 to be refilled is mounted to print engine 20. An imaging substance conduit 28 fluidly couples cartridge refill device 24 to printing cartridge 26 for supplying an imaging substance, e.g., ink or toner, from cartridge refill device 24 to printing cartridge 26.

Cartridge refill system 10 optionally may communicate with a database 30 via communication port 16 over a communication link 32 using a standard communication protocol, such as for example, universal serial bus (USB), Ethernet, IEEE 802.xx, or Internet. Accordingly, communication link 32 may be a wired or wireless link. As used herein, the term “database” is a database that may be external (e.g., remote) or internal (e.g., formed in memory 14) to cartridge refill system 10.

In the present embodiment, controller 12 communicates with communication port 16 via a communications link 34. Controller 12 communicates with user interface 18 via a communications link 36. Controller 12 communicates with print engine 20 via a communications link 38. Controller 12 communicates with printing cartridge 26 via a communications link 40. Controller 12 communicates with scanner 22 via a communications link 42. Controller 12 communicates with cartridge refill device 24 via a communications link 44. As used herein, the term “communications link” includes a wired path, a wireless path, or a combination thereof.

Controller 12 includes a processor unit and associated memory 14, and may be formed as one or more Application Specific Integrated Circuits (ASIC). Memory 14 may be, for example, random access memory (RAM), read only memory (ROM), and/or non-volatile RAM (NVRAM). Alternatively, memory 14 may be in the form of a separate electronic memory (e.g., RAM, ROM, and/or NVRAM), a hard drive, a CD or DVD drive, or any memory device convenient for use with controller 12. Controller 12 may be, for example, a combined printer/scanner controller for controlling and facilitating data transfer with either of print engine 20 or scanner 22.

In general, controller 12 interrogates printing cartridge 26 during a refilling operation, and controls cartridge refill device 24 during the refilling operation in accordance with the interrogation. Thereafter, controller 12 may operate print engine 20 to print a print sample 45-1, e.g., a test image, on a print medium 45, such as paper, generated using the refilled printing cartridge 26, and thereafter control scanner 22 to scan print sample 45-1 to generate scanner data associated with the test image. Controller 12 then processes the scanner data to determine whether the refill of printing cartridge 26 meets the minimum operating standards associated with printing cartridge 26.

In one implementation, for example, printing cartridge 26 may be installed once in cartridge refill system 10 and print sample 45-1 is moved automatically from print engine 20 to scanner 22 for scanner evaluation. Alternatively, in another implementation, an operator may manually move printing cartridge 26 from cartridge refill device 24 to a print engine, e.g., print engine 20, to print the print sample 45-1, e.g., test image, on print medium 45, and then the operator manually places the print sample 45-1 on scanner 22 for scanner evaluation.

Print engine 20 may be, for example, an ink jet print engine or an electrophotographic (e.g., laser) print engine, which includes hardware and electrical components to transport print medium 45 through a print zone, in a manner well known in the art, to form a printed image on the print medium.

In the case where print engine 20 is an ink jet print engine, print engine 20 may include a reciprocating carrier for mounting and carrying printing cartridge 26, and include a printhead maintenance station for cleaning the printhead associated with printing cartridge 26. Printing cartridge 26 may be in the form of an integral ink jet printhead cartridge, wherein an ink tank and printhead are formed as a non-separable unit, so as to be replaceable as a unit. In another embodiment, printing cartridge 26 may have the ink tank without the integral printhead, so that the printhead and ink tank are separable, and thus individually replaceable.

In the case where print engine 20 is an electrophotographic print engine, printing cartridge 26 may be in the form of a toner cartridge having a toner reservoir, or an electrophotographic cartridge having additional components, such as a photoconductive member (e.g., belt or drum), toner transfer drum, cleaning device, etc., in addition to the toner reservoir.

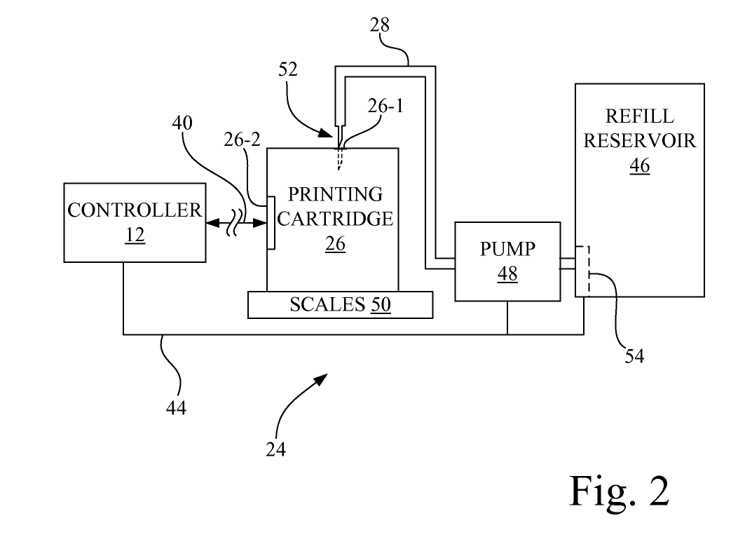

Referring to FIG. 2, cartridge refill device 24 is configured to transfer an imaging substance to printing cartridge 26 during a refill operation. Cartridge refill device 24 may include, for example, a refill reservoir 46, a pump 48, a scales 50 and a refill interface device 52. Refill interface device 52 is connected to imaging substance conduit 28. Refill interface device 52 is configured to engage a refill port 26-1 of printing cartridge 26, such as for example, through a removable plug, or by a needle/hole arrangement, to facilitate a flow of imaging substance into printing cartridge 26. For example, refill interface device 52 may be vertically displaced to penetrate a hole or septum located at refill port 26-1 of printing cartridge 26, as depicted by dashed lines.

After refill interface device 52 is engaged with refill port 26-1 of printing cartridge 26, pump 48 may be selectively activated by controller 12, as further described below, to pump imaging substance from refill reservoir 46 into printing cartridge 26. Scales 50 (which is optional) determines a mass of printing cartridge 26 during the refill operation, and sends a signal to controller 12 when the mass, or weight, of printing cartridge 26 corresponds to a predetermined threshold level, such as a threshold value indicating that printing cartridge 26 is full of imaging substance. Alternatively, controller 12 may monitor the amount of imaging substance removed from refill reservoir 46, such as by monitoring the amount of imaging substance moved by pump 48, or through other flow sensor or level sensor arrangements.

Alternatively, cartridge refill device 24 may be configured as a free feeding device, thereby eliminating pump 48. In such a configuration, refill reservoir 46 feeds imaging substance directly by the force of gravity and/or siphoning action to printing cartridge 26 via imaging substance conduit 28 and refill interface device 52.

Cartridge refill device 24 may further include a mixing device 54 (depicted by dashed lines) mounted to refill reservoir 46, which meters amounts of multiple imaging substances and/or additives to formulate custom formulations, such as custom inks or custom toners, and wherein refill reservoir 46 includes multiple compartments containing different colors of imaging substances, and/or one or more additives. In the context of inks, for example, such additives include such things as ink dilution substances, biocides, etc., as is known in the art.

Controller 12 is communicatively coupled to mixing device 54 via communications link 44. Controller 12 operates mixing device 54 to formulate an imaging substance composition from a plurality of component parts. The plurality of component parts may include, for example, at least two components selected from a plurality of imaging substances and additives.

Accordingly, for example, cartridge refill system 10 can formulate from multiple inks (for example: cyan (C), magenta (M), yellow (Y), and black (K)) a new custom colored ink that is injected into printing cartridge 26, if desired. Inks available for mixing in cartridge refill system 10 may include additional ones not normally used in refilling color cartridges, which may thus expand the available color gamut into specific ranges of color that are poorly defined by CMY inks, such as for example, orange and green inks. Mixing such inks or ink additives may be particularly important if the customer needs a close match to a target color.

As shown in FIG. 2, printing cartridge 26 may include a memory device 26-2, which is connected by communication link 40 to controller 12. Memory device 26-2 may be, for example, semiconductor memory such as flash memory, which may be integrated with other circuitry, such as for example on a printhead heater chip. Alternatively, memory device 26-2 may be implemented, for example, as a bar code device, a radio frequency identification device (RFID), mechanical keys or interlocks, and other specialty circuits.

Memory device 26-2 has stored thereon machine readable data that is processed by controller 12. Examples of such machine readable data include printing cartridge type, serial number, ink batch, manufacture date, ink (or toner) usage, temperature, date and time of last use, etc. Such information is typically used by a printer to better process print jobs and provide status information to the printer operator (or network administrator). For example, different color tables may be used depending on which ink is available; different maintenance (off-line purging and wiping of the printhead) schedules may be adopted depending on type of ink or usage of the cartridge; ink level indicators can be reset based on cartridge type, ID number, and usage (even if a cartridge is removed temporarily and replaced); and printers can be programmed to function only with cartridges of selected brands.

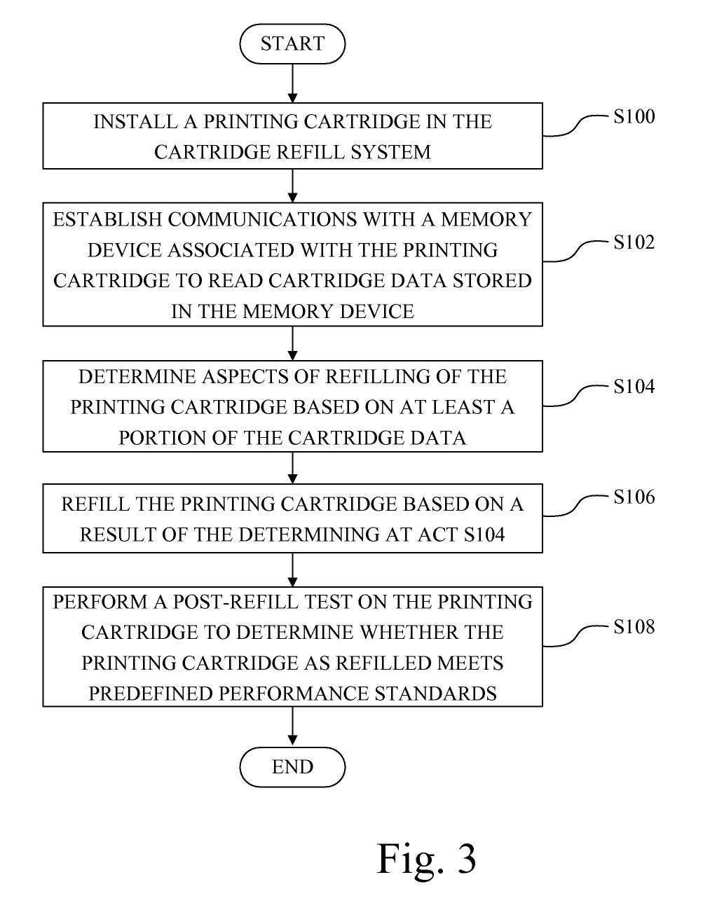

FIG. 3 is a general flowchart of a method for refilling a printing cartridge, in accordance with an embodiment of the present invention. The method may be implemented as program instructions executed by controller 12 of cartridge refill system 10.

At act S100, a printing cartridge, such as printing cartridge 26, is installed in cartridge refill system 10.

More particularly, in the present embodiment printing cartridge 26 is installed in print engine 20. Also, refill interface device 52 may be engaged at this time with refill port 26-1 of printing cartridge 26 to facilitate a flow of imaging substance from refill reservoir 46 into printing cartridge 26. Alternatively, the engagement of refill interface device 52 with printing cartridge 26 may occur at any time prior to the actual refilling of printing cartridge 26, e.g., prior to act S106 in the present method.

At act S102, communications is established with a memory device associated with the printing cartridge to read cartridge data stored in the memory device. The memory device may be, for example, memory device 26-2 located on printing cartridge 26 and/or remote database 30. In the present embodiment, upon initiating a refilling operation, e.g., via user interface 18, controller 12 establishes communication with the memory device. Typically, communications will be established at least with memory device 26-2 located on printing cartridge 26, e.g., communications link 40. However, in some embodiments, alternatively or supplemental to memory device 26-2, communications may be established with database 30, which may also contain cartridge data associated with printing cartridge 26.

At act S104, aspects of refilling of printing cartridge 26 are determined based on at least a portion of the cartridge data.

In accordance with an aspect of the present invention, the refilling process is variable depending on what information is detected in the cartridge data stored on the memory device 26-2 of printing cartridge 26 and/or stored in database 30, so as to sustain the performance and print quality of printing cartridge 26. For example, controller 12 may analyze the cartridge data stored on memory device 26-2 of printing cartridge 26 to determine which inks may be used for that particular printing cartridge. In most cases, the original ink is replaced. However, ink composition may be modified or supplemented by additives that extend life of refilled cartridges.

As another example, if data on ink usage is stored on memory device 26-2, then controller 12 may adjust the amount of ink prescribed based on that usage data for each color. This is particularly useful in a multi-color printing cartridge, wherein individual colors of imaging substance may be used at different rates and thus would require different amounts of imaging substance to complete the refill of the printing cartridge.

As another example, controller 12 may check the cartridge data, such as serial number, batch, manufacturing date, stored on memory device 26-2 to identify design levels or production versions that merit additional cleaning, different ink formulation, variable rates of fill, or authorization of fewer refills.

As another example, controller 12 may write to memory device 26-2 to reset ink level data stored in the cartridge data, so as to reflect the ink yield expected after the refilling of printing cartridge 26. It is noted that in some printing cartridges, without resetting, ink level indicators are usually non-functional or inaccurate after refilling. Also, the yield of the printing cartridge may be expected to decline with each refill, so recording the number of refills in the cartridge data may be important in accurately resetting an ink level indicator.

In addition, cartridge refill system 10 is configured to access and exchange information with remote data systems, such as database 30, which may be used during the refilling of printing cartridge 26. This feature allows the refill process to be improved based on retrieval of further information about the specific cartridge, e.g., printing cartridge 26, that is being refilled. For example, the combination of data from the memory device 26-2 of printing cartridge 26 and data from database 30 may assure the best combination of actions in the refilling process, and results in an intelligent refill process optimized uniquely for each cartridge.

Database 30 may be directly accessible during the cartridge refill process, or alternatively, database 30 may be accessed periodically to access information relating to a printing cartridge, and store the cartridge information retrieved from database 30 (remote) in a local database memory, such as in memory 14 of cartridge refill system 10.

In addition, a customer may supplement or override the cartridge information retrieved from memory device 26-1 and/or database 30 via user interface 18, such as by entered a predetermined code.

At act S106, printing cartridge 26 is refilled based on a result of the determining at act S104.

For example, a standard imaging substance transfer may occur, as more fully described above, wherein imaging substance is supplied, e.g., by pump 48 or by gravity feed, from refill reservoir 46 into printing cartridge 26. Controller 12 monitors the amount of imaging substance delivered to printing cartridge 26, e.g., via one or more sensor arrangements, such as scales 50, or other flow sensor or level sensor arrangements.

In addition, however, component inks and/or ink plus ink additives may be mixed by cartridge refill device 24 using mixing device 54 under the control of controller 12 based on a code provided to controller 12, e.g., by a customer via user interface 18, or alternatively by a code stored in memory device 26-2 of printing cartridge 26. The code may, for example, correspond to a color standard such as the Pantone system or correspond to color samples provided for customer reference. Also, the color codes may be different depending on properties of the paper or other media that will be printed. The code is processed by controller 12, and used to access a lookup table, which may be established for example in memory 14 or database 30, to correlate the code to the proper proportions of the imaging substance colors and/or additives available from refill reservoir 46.

Also, for some printing cartridges 26, such as an ink jet printhead cartridge, it may be desirable to perform a cleaning/washing/wiping of the associated printhead, in addition to adding more imaging substance. Such a cleaning/washing/wiping operation may be integral with the refilling operation, and may be performed in time before or after the actual refilling of printing cartridge 26.

At act S108, post-refill test is performed on printing cartridge 26 to determine whether printing cartridge 26 as refilled meets predefined performance standards.

For example, after cartridge refill system 10 has refilled printing cartridge 26, a post-refill test of printing cartridge 26 is performed to determine whether the refilled printing cartridge meets predefined standards. The post-refill test includes, for example, generating print sample 45-1 and evaluating print sample 45-1 to identify any printing defects.

For example, controller 12 may activate print engine 20 to generate print sample 45-1, e.g., a printed test pattern, on print medium 45, such as a sheet of paper, which in turn is optically scanned by scanner 22 to generate scanner data corresponding to print sample 45-1. Scanner 22 provides the scanner data to controller 12, which in turn processes the scanner data to identify typical defects, including for example: voids, banding, misdirection, coverage, density, consistency, and color, which are present in print sample 45-1.

Any of a variety of print patterns may be used, such as for example, the printing of a single solid patch, and/or the printing of multiple horizontally spaced blocks or lines, the printing of horizontally spaced diagonal blocks or lines, etc. If printing cartridge 26 as refilled passes the post-refill test, then printing cartridge 26 may be certified as meeting minimum performance standards associated with a particular cartridge type of printing cartridge 26. Otherwise, if printing cartridge 26 as refilled does not pass the post-refill test, then printing cartridge 26 would not be certified as meeting minimum performance standards associated with that particular cartridge type.

Optional processes may be added to the process acts described above.

For example, optionally, cartridge refill system 10 may be further configured to determine whether a printing cartridge may be refilled. For example, based on cartridge data read from memory device 26-2 of printing cartridge 26 and/or database 30, controller 12 makes a decision as to whether or not printing cartridge 26 may be refilled, such as for example, if printing cartridge 26 is believed to be sub-standard. As a more specific example, it may be determined that printing cartridge 26 has exceeded predefined criteria, such as the level of usage, shelf life, etc., that can be assured of meeting expected performance standards, in which case refilling would not be permitted. Also, controller 12 may perform auxiliary tests, such as an electrical stress test on electrical components of printing cartridge 26, or a pH test, wherein if the test fails, refilling would not be permitted. If a cartridge is rejected for refill, then that cartridge ID in the cartridge data may be recorded in database 30 to record the rejection. Alternatively, the information stored on memory device 26-2 of printing cartridge 26 may be modified to alert printers and refill systems that this cartridge is deficient.

Also, cartridge refill system 10 may be further configured to send information regarding the cartridge and the refill transaction to database 30, e.g., directly or in periodic batches. Such information may be used to build a database of cartridge performance for one or more printing cartridges that can be used later to design better cartridges and refill processes.

Customer data provided by cartridge refill system 10 may also be acquired and transferred to database 30, and later retrieved in the manner of Customer Relationship Management (CRM) techniques widely used by marketing organizations. This data may be used to develop marketing programs that reward high volume customers, such as authorizing discounts on products and services to customers that provide a phone number or customer ID number when a refill is processed. For example, cartridge information retrieved from memory device 26-2 of printing cartridge 26 and/or database 30 may be used for business purposes, such as for example, to improve the refilling experience for the customer, to facilitate a customer rewards program, etc. Such a rewards program may reward a customer for attaining a certain number of refills by such gifts as a free or reduced cost refill, or a free or reduced cost new printing cartridge.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for refilling a printing cartridge, comprising:
installing a printing cartridge in a cartridge refill system;
establishing communication with a memory device associated with said printing cartridge to read cartridge data stored in said memory device;
determining aspects of refilling of said printing cartridge based on at least a portion of said cartridge data; and
refilling said printing cartridge based on a result of said determining.

2. The method of claim 1, further comprising performing a post-refill test on said printing cartridge to determine whether said printing cartridge as refilled meets predefined performance standards.

3. The method of claim 2, wherein said post-refill test includes:
generating a print sample; and
evaluating said print sample to identify printing defects in said print sample.

4. The method of claim 2, wherein if said printing cartridge as refilled passes said post-refill test, then said printing cartridge is certified as meeting minimum performance standards associated with a particular cartridge type of said printing cartridge.

5. The method of claim 1, wherein the act of determining includes selecting a particular ink for use in refilling said printing cartridge.

6. The method of claim 1, wherein the act of determining includes selecting additives that extend life of refilled cartridges for inclusion in refilling said printing cartridge.

7. The method of claim 1, wherein said determining includes adjusting an amount of ink prescribed for said refilling based on ink usage data stored in said memory device.

8. The method of claim 1, wherein said determining includes identify versions of said printing cartridge that merit at least one of additional cleaning, different ink formulation, variable rates of fill, or authorization of fewer refills.

9. The method of claim 1, wherein said determining includes determining whether said printing cartridge is sub-standard, based on said cartridge data, prior to permitting refilling of said printing cartridge.

10. The method of claim 1, wherein said determining includes formulating a custom colored imaging substance to be used in refilling said printing cartridge.

11. The method of claim 1, further comprising resetting an ink level indicator in said memory device to signify a refilling of said printing cartridge.

12. The method of claim 1, further comprising acquiring additional information relating to said printing cartridge from a remote database.

13. The method of claim 1, further comprising storing information relating to said refilling of said printing cartridge to a remote database.

14. The method of claim 1, further comprising rewarding a customer for attaining a certain number of refills.

15. A cartridge refill system for refilling a printing cartridge having a memory device, comprising:
a print engine configured to mount said printing cartridge to be refilled;
a cartridge refill device having a refill reservoir containing at least an imaging substance, and having a refill interface device coupled to said refill reservoir and configured to engage said printing cartridge; and
a controller communicatively coupled to said print engine and said cartridge refill device, said controller executing program instructions to perform the acts of:
establishing communication with said memory device associated with said printing cartridge to read cartridge data stored in said memory device;
determining aspects of refilling of said printing cartridge based on at least a portion of said cartridge data; and
refilling said printing cartridge based on a result of said determining.

16. The cartridge refill system of claim 15, said controller executing program instructions to perform the further act of performing a post-refill test on said printing cartridge to determine whether said printing cartridge as refilled meets predefined performance standards.

17. The cartridge refill system of claim 16, further comprising a scanner communicatively coupled to said controller, and wherein said post-refill test includes:
said controller activating said print engine to generate a print sample on a print medium; and
said controller activating said scanner to scan said print sample to generate scanner data associated with said print sample, said controller evaluating said scanner data to identify printing defects in said print sample.

18. The cartridge refill system of claim 16, wherein if said printing cartridge as refilled passes said post-refill test, then said printing cartridge is certified as meeting minimum performance standards associated with a particular cartridge type of said printing cartridge.

19. The cartridge refill system of claim 15, wherein the act of determining includes at least one of:
selecting a particular ink for use in refilling said printing cartridge;
selecting an additive that extends life of refilled cartridges for inclusion in refilling said printing cartridge;
adjusting an amount of ink prescribed for said refilling based on ink usage data stored in said memory device; and
identifying versions of said printing cartridge that merit at least one of additional cleaning, different ink formulation, variable rates of fill, or authorization of fewer refills.

20. The cartridge refill system of claim 15, further comprising a mixing device coupled to said refill reservoir, said mixing device being communicatively coupled to said controller, said controller operating said mixing device to formulate an imaging substance composition from a plurality of component parts for refilling said printing cartridge.
